(19) United States
(12) Patent Application Publication
(10) Pub. No.: US 2017/0199427 A1
(43) Pub. Date: Jul. 13, 2017

(54) Liquid Crystal Display Device With Reflective Unit

(71) Applicant: Wuhan China Star Optoelectronics Technology Co., Ltd., Wuhan (CN)

(72) Inventors: Chunqian ZHANG, Shenzhen (CN); Chao WANG, Shenzhen (CN); Jingfeng Xue, Shenzhen (CN); Qiang GONG, Shenzhen (CN)

(73) Assignee: Wuhan China Star Optoelectronics Technology Co., Ltd., Wuhan (CN)

(21) Appl. No.: 15/075,190

(22) Filed: Mar. 20, 2016

(30) Foreign Application Priority Data
Jan. 11, 2016 (CN) 2016100150258

(51) Int. Cl. G02F 1/1335; G02F 1/13363; G02F 1/1368

(52) U.S. Cl. CPC G02F 1/133555; G02F 1/133514; G02F 1/1368; G02F 1/133553; G02F 1/1335; G02F 1/13363; G02F 1/133528; G02F 2001/133565

(57) ABSTRACT

The present disclosure provides a liquid crystal display device with reflective region. The liquid crystal display device includes: a CF substrate is disposed opposite with a TFT substrate and a liquid crystal layer arranged between the CF substrate and the TFT substrate; a reflective layer arranged between the TFT substrate and the liquid crystal layer, after external light passing through the CF substrate and the liquid crystal layer the light will be reflected by the reflective layer; a wavelength converting layer arranged between the reflective layer and the CF substrate is used to convert ultraviolet light to green light. In such a mode, the present disclosure can reduce amount of ultraviolet light and increase amount of green light, in order to reduce damage to the eyes and increase brightness in reflection.

### FIELD OF THE DISCLOSURE

The present disclosure relates to a display technology field, and more particularly to a liquid crystal display device with reflective unit.

### BACKGROUND OF THE DISCLOSURE

Conventional liquid crystal display device includes transmissive, reflective and transflective type. The transmissive liquid crystal display device uses the backlight as the light source, and a polarized light is formed after passing through a lower polarizer, the direction of the polarization is deflected by a liquid crystal, then passes through an upper polarizer. In transmissive type liquid crystal display device, backlight power is an important part of power consumption of the display device.

The conventional reflective liquid crystal display adds a reflector on a Thin Film Transistor (TFT), the light source is provided by reflecting ambient light. In reflective liquid crystal display, the intensity of the ambient light is not easy to control even the light passes through twice so that its brightness is too low.

The conventional transflective liquid crystal display is divided one pixel into two parts used to the reflective type when the ambient light is higher, and used to transmissive type to switch on the backlight when the ambient light is lower. But still have the problem of low brightness in the reflective type.

### SUMMARY OF THE DISCLOSURE

The present disclosure to solve the technical problem is to provide a liquid crystal display device with reflective region, the brightness can be improved.

In order to solve the above problems, the technical aspect of the present disclosure is used: using a liquid crystal display device with reflective region, the liquid crystal display includes: a CF substrate is disposed opposite with a TFT substrate and a liquid crystal layer arranged between the CF substrate and the TFT substrate; a reflective layer arranged between the TFT substrate and the liquid crystal layer, after external light passing through the CF substrate and the liquid crystal layer the light will be reflected by the reflective layer; a wavelength converting layer arranged between the reflective layer and the CF substrate is used to convert ultraviolet light to green light.

Further, the wavelength converting layer arranged between the CF substrate and the liquid crystal layer or between the liquid crystal layer and the reflective layer.

Further, surface of the wavelength converting layer is set to be uneven, in order to improve optical absorptivity of the wavelength converting layer.

Further, the wavelength converting layer is (Sr,Ba)₂Si₄:Eu²⁺.

Further, surface of the reflective layer is set to be uneven, in order to improve reflection angle of light.

Further, the wavelength converting layer is deposited by using magnetron sputtering to deposit (Sr,Ba)₂Si₄ with Eu²⁺ on surface of the reflective layer.

Further, the liquid crystal display device further includes a retardation film and a first polarizer, the retardation film and the first polarizer successively disposed on the CF substrate, the retardation film is used to compensate for the phase difference of light, in order to pass through the first polarizer.

Further, the liquid crystal display device is a total reflection liquid crystal display device.

Further, the liquid crystal display device is a transflective liquid crystal display device, the liquid crystal display device includes a transmissive region and a reflective region, the wavelength converting layer and the reflective layer are arranged in the reflective region, thickness of the TFT substrate of the transmissive region is greater than thickness of the TFT substrate of the reflective region.

Further, the liquid crystal display device includes a second polarizer and a backlight module arranged on outer of the TFT substrate, the second polarizer is between the backlight module and the TFT substrate, the backlight module provides light to the transmissive region, the second polarizer polarizes incident light.

The beneficial effects of the present disclosure are: the situation is different from the prior art, the present disclosure provides a liquid crystal display device with reflective region, the liquid crystal display includes: a CF substrate is disposed opposite with a TFT substrate and a liquid crystal layer arranged between the CF substrate and the TFT substrate, a reflective layer and a wavelength converting layer. The reflective layer arranged between the TFT substrate and the liquid crystal layer, after external light passing through the CF substrate and the liquid crystal layer the light will be reflected by the reflective layer, the wavelength converting layer arranged between the reflective layer and the CF substrate is used to convert ultraviolet light to green light. Thus, the present disclosure can reduce amount of ultraviolet light and increase amount of green light to reduce reflective radiation of liquid crystal display to ultraviolent light, reduce damage to the eyes, reduce power consumption and increase brightness in reflection.

### BRIEF DESCRIPTION OF THE DRAWINGS

FIG. 1 is a schematic structural view of a liquid crystal display device with reflective region of the present disclosure embodiment.

FIG. 2 is a schematic diagram of a wavelength converting layer converting wavelength of light.

FIG. 3 is a schematic structural view of another liquid crystal display device with reflective region of the present disclosure embodiment.

### DETAILED DESCRIPTION OF PREFERRED EMBODIMENTS

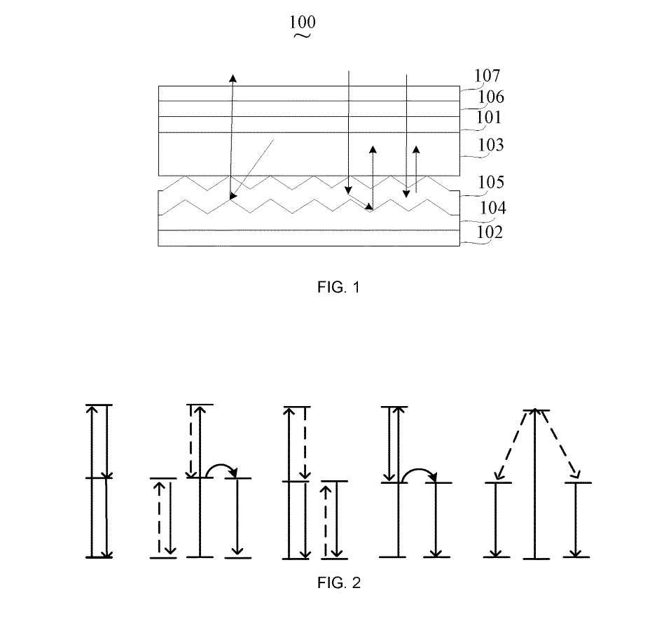

Refer to FIG. 1, FIG. 1 is a schematic structural view of a liquid crystal display device with reflective region of the present disclosure embodiment. The liquid crystal display device 10 of the present disclosure embodiment includes a CF substrate 101, a TFT substrate 102, a liquid crystal layer 103, a reflective layer 104 and a wavelength converting layer 105 shown in FIG. 1.

Further, the CF substrate 101 is disposed opposite with the TFT substrate 102, and the liquid crystal layer 103 is arranged between the CF substrate 101 and the TFT substrate 102. The reflective layer 104 is arranged between the TFT substrate 102 and the liquid crystal layer 103, after external light passing through the CF substrate 101 and the liquid crystal layer 103, the light will be reflected by the reflective layer 104. The wavelength converting layer 105 arranged between the reflective layer 104 and the CF substrate 101 is used to convert ultraviolet light to green light.

Thus, the present disclosure can reduce amount of ultraviolet light and increase amount of green light to reduce reflective radiation of liquid crystal display to ultraviolent light, reduce damage to the eyes, reduce power consumption and increase brightness in reflection.

In the present embodiment, the wavelength converting layer 105 arranged between the liquid crystal layer 103 and the reflective layer 104.

Further, the surface of the wavelength converting layer 105 is set to be uneven, in order to improve optical absorptivity of the wavelength converting layer. Such as, in the present embodiment, surface of wavelength converting layer 105 is set to be sawtooth, in other embodiment, surface of wavelength converting layer 105 further can set to be wavy or others.

In other embodiment, the wavelength converting layer 105 further can arranged between the CF substrate 101 and the liquid crystal layer 103.

Further, material of the wavelength converting layer 105 is rare metal ions, can quantum cutting light or wavelength converting light in a suitable carrier, i.e. emitting a longer wavelength after one of the shorter wavelength converted. Various clipping mechanisms is shown in FIG. 2, further, the solid line of arrow down, the solid line of arrow up and the dotted line arrow means excitation, emission and energy transfer process. In the solar spectrum, in addition to visible light, there is ultraviolet, the ultraviolet is no contribution in reflective liquid crystal display. The brightness will be improved, reduced reflective radiation of liquid crystal display to ultraviolent light and reduced damage to the eyes by quantum cutting the ultraviolent light to be visible light, such as green light.

In the present embodiment, material of the wavelength converting layer 105 is preferably (Sr,Ba)₂Si₄ with EU²⁺. Preferably is (Sr,Ba)₂Si₄:EU²⁺, further, (Sr,Ba)₂Si₄:EU²⁺ capable of absorbing ultraviolet light of 300-400 nm, and emitting green light of 535 nm about, the specific principles as previously described. The green light happens to be the most sensitive wavelength components to the human eye. The wavelength converting layer of the present embodiment is deposited by using magnetron sputtering to deposit (Sr,Ba)₂Si₄ with Eu²⁺ on surface of the reflective layer. The green light is converted by the external incident ultraviolet light passing through the compound of (Sr,Ba)₂Si₄ with Eu²⁺, and the green light is emitted as a part of the light source to the liquid crystal layer 103 by passing through the reflective layer 104. The remaining visible light transmits through the wavelength converting layer 105 directly, and is reflected as the light source emitting to the liquid crystal layer 103 by the reflective layer 104. Thus can improve brightness of the reflective liquid crystal display device. Shown in FIG. 1, there is some incident light emits directly after passing through the wavelength converting layer 105.

In the present embodiment, surface of the reflective layer 104 is set to be uneven, in order to improve reflection angle of light, and improve the viewing angle. Specific shape of the surface of the reflective 104 is same as the wavelength converting layer 105, are not discussed here.

Retardation of incident light is influenced by the wavelength converting layer 105, thus the present disclosure embodiment further includes a retardation film 106 arranged on the CF substrate 101, in order to compensate for the phase difference of light. Specifically, the present embodiment further includes a polarizer 107 arranged on the retardation film 106. Retardation film 106 is used to compensate for the phase difference light of the wavelength converting layer 105, the liquid crystal layer 103 and reflective layer 104. Let retardation of the reflective layer 104 be φR, retardation of the wavelength converting layer 105 be φS, retardation of off state liquid crystal 103 be φLc (for normally black mode, usually guaranteed outgoing and incoming light polarization direction of off state is vertical, but once adding voltage, deflect liquid crystal, transmittance ratio is relevant the adding voltage, so only to define the parameters according to the situation of off state), retardation of the retardation film 106 be φ, then there is the relationship φR +φS+φLc=π/2. In order to emit the light to an appropriate polarization and pass through the polarizer 107.

The present embodiment provided is a schematic structural view of a total reflection liquid crystal display device. In the present disclosure, the reflective layer 104 and the wavelength converting layer 105 are equivalent-width with the TFT substrate 102.

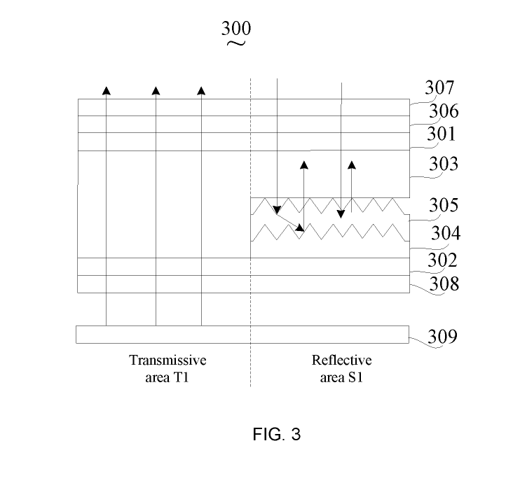

The present disclosure further provides a schematic structural view of a transmissive liquid crystal display device. Shown in FIG. 3, a liquid crystal display device 300 still includes a CF substrate 301, a TFT substrate 302, a liquid crystal layer 303, a reflective layer 304, a wavelength converting layer 305, a retardation film 306 and a polarizer 307. The CF substrate 301, the liquid crystal layer 303, the retardation film 306 and the polarizer 307 are similar as previously described of the CF substrate 101, the liquid crystal layer 103, the retardation 106 and the polarizer 107, are not discussed here.

Difference between the liquid crystal display device 300 of the present embodiment and the liquid crystal display device 100 is the liquid crystal display device 300 of the present embodiment further includes a transmissive area T1 and a reflective area S1, the wavelength converting layer 305 and the reflective layer 304 are arranged in the reflective area S1, and thickness of the TFT substrate 302 in the transmissive area T1 is greater than the TFT substrate in the reflective area S1. Specifically, the method is set different thickness of the transmissive area T1 and the reflective area S1 at the planarization layer (PLN layer) between the second metal layer (i.e., a metal layer forming a source electrode and a drain electrode) and a Botton ITO (i.e., a common electrode layer) on the TFT substrate 302. In order to make electro-optical characteristics matched transmission and reflection.

Further, the liquid crystal display device 300 includes a polarizer 308 and a backlight module 309 arranged outer of the TFT substrate 302, and the polarizer 308 is between the backlight module 309 and the TFT substrate 302, and the backlight module 309 provides light source to the transmissive area T1, and the polarizer 308 polarizes incident light.

In the transflective liquid crystal display device of the present embodiment, surface of the reflective layer 304 in the reflective area S1 is deposited the wavelength converting layer 305 by using magnetron sputtering. And the area ratio of the reflective area S1 and the transmissive T1 can be adjustment based on the needs, such as the needs is achieving better brightness and display effect in transmissive display so that increase area of the transmissive area T1 and reduce area of the reflective area S1, conversely, the needs is achieving better brightness and display effect in reflective display so s reduce area of the transmissive area T1 and increase area of the reflective area S1. The present embodiment is also set surface of the reflective 304 and the wavelength converting layer 305 to be uneven, in order to improve the viewing angle, and improve light absorption of the wavelength converting layer 305.

The retardation film 306 of the present embodiment is used to compensate for the phase difference light of the liquid crystal layer 303, the wavelength converting layer 305 and the reflective layer 304 of the reflective area S1, and light of the liquid crystal layer 303 of the transmissive area T1. Such as, let a retardation formed by reflective 304 of the reflective area S1 be φR, a retardation formed by the wavelength converting layer 305 be φS, a retardation formed by the off state reflective area liquid crystal layer be φLC1, a retardation formed by the liquid crystal layer 303 of the transmissive area T1 be φLC2, then φR+φS+φLc1=φLc2, let a retardation formed by the retardation film 306 be φ, then φLc+φ=π/2.

In summary, the present disclosure can reduce amount of ultraviolet light and increase amount of green light to reduce reflective radiation of liquid crystal display to ultraviolent light, reduce damage to the eyes, reduce power consumption and increase brightness in reflection.

The above are only embodiments of the present disclosure is not patented and therefore limit the scope of the present disclosure, any use made of the present disclosure specification and drawings equivalent structures or equivalent process transformation, either directly or indirectly related technologies used in other areas are included in the patent empathy scope of the disclosure.

What is claimed is:

1. A liquid crystal display device with reflective unit, wherein the liquid crystal display device comprises:
a CF substrate is disposed opposite with a TFT substrate and a liquid crystal layer arranged between the CF substrate and the TFT substrate;
a reflective layer is arranged between the TFT substrate and the liquid crystal layer, after external light passing through the CF substrate and the liquid crystal layer the light will be reflected by the reflective layer;
a wavelength converting layer arranged between the reflective layer and the CF substrate is used to convert ultraviolet light to green light.

2. The liquid crystal display device according to claim 1, wherein the wavelength converting layer is arranged between the CF substrate and the liquid crystal layer or between the liquid crystal layer and the reflective layer.

3. The liquid crystal display device according to claim 1, wherein surface of the wavelength converting layer is set to be uneven, in order to improve optical absorptivity of the wavelength converting layer.

4. The liquid crystal display device according to claim 3, wherein the wavelength converting layer is (Sr,Ba)₂Si₄:Eu²⁺.

5. The liquid crystal display device according to claim 4, wherein surface of the reflective layer is set to be uneven, in order to improve reflection angle of light.

6. The liquid crystal display device according to claim 5, wherein the wavelength converting layer is deposited by using magnetron sputtering to deposit (Sr,Ba)₂Si₄ with Eu²⁺ on surface of the reflective layer.

7. The liquid crystal display device according to claim 1, wherein the liquid crystal display device further comprises a retardation film and a first polarizer, the retardation film and the first polarizer successively disposed on the CF substrate, the retardation film is used to compensate for the phase difference of light, in order to pass through the first polarizer.

8. A liquid crystal display device according to claim 7, wherein the liquid crystal display device is a total reflection liquid crystal display device.

9. The liquid crystal display device according to claim 7, wherein the liquid crystal display device is a transflective liquid crystal display device, the liquid crystal display device comprises a transmissive region and a reflective region, the wavelength converting layer and the reflective layer are arranged in the reflective region, thickness of the TFT substrate of the transmissive region is greater than thickness of the TFT substrate of the reflective region.

10. The liquid crystal display device according to claim 9, wherein the liquid crystal display device comprises a second polarizer and a backlight module arranged on outer of the TFT substrate, the second polarizer is between the backlight module and the TFT substrate, the backlight module provides light to the transmissive region, the second polarizer polarizes incident light.
